(19) United States
(12) Patent Application Publication
(10) Pub. No.: US 2019/0189041 A1
(43) Pub. Date: Jun. 20, 2019

(54) DISPLAY DEVICE AND ELECTRONIC SHELF LABEL SYSTEM

(71) Applicant: Japan Display Inc., Tokyo (JP)

(72) Inventors: Koji ISHIZAKI, Tokyo (JP); Takao AMBAI, Tokyo (JP); Taro ICHIMURA, Tokyo (JP)

(21) Appl. No.: 16/220,738

(22) Filed: Dec. 14, 2018

(30) Foreign Application Priority Data
Dec. 15, 2017 (JP) 2017-240551

(51) Int. Cl. G09G 3/20; G06F 3/041; G06F 3/01; G06F 3/0484; G06Q 30/06

(52) U.S. Cl. CPC G09G 3/20; G06F 3/0416; G06Q 30/0643; G06F 3/017; G06F 3/04845; G06F 3/0412

(57) ABSTRACT

According to one embodiment, a display device includes a display, a touchpanel, a memory and a processor. The display displays a shelf label image including a product information item of a product displayed on a display shelf. The touchpanel in or on the display detects a contact position of an object. The processor executes a program stored in the memory, makes a state of the touchpanel from an inactive state to an active state when an external terminal is connected to the display device, detects a type of an action, based on the contact position of the object detected by the touchpanel in the active state, changes the shelf label image displayed on the display in accordance with the type of the action.

### CROSS-REFERENCE TO RELATED APPLICATIONS

This application is based upon and claims the benefit of priority from Japanese Patent Application No. 2017-240551, filed Dec. 15, 2017, the entire contents of which are incorporated herein by reference.

### FIELD

Embodiments described herein relate generally to a display device and an electronic shelf label system.

### BACKGROUND

In general, display shelves for displaying products are installed in stores such as supermarkets or retail stores. On these display shelves, a plurality of products are displayed, and price tags and point-of-purchase advertisements made of paper, which are associated with the respective products, are stuck. However, when the products are replaced or when the prices of the products fluctuate, employees must manually replace the price tags and point-of-purchase advertisements made of paper associated with the respective products on the display shelves. Thus, the price tags and point-of-purchase advertisements made of paper are disadvantageous in that the employees' workloads are heavy.

Therefore, in recent years, progress has been made towards a paperless system by mounting electronic shelf labels (ESL) which can display shelf label images including product information items on products, instead of price tags and point-of-purchase advertisements made of paper, on the display shelves. This can reduce the employees' workloads.

With the spread of such a paperless system, it has been newly requested that the shelf label images be easily changed on site.

### SUMMARY

The present application relates generally to a display device and an electronic shelf label system.

According to one embodiment, a display device includes a display, a touchpanel, a memory and a processor. The display displays a shelf label image including a product information item of a product displayed on a display shelf. The touchpanel in or on the display detects a contact position of an object. The processor executes a program stored in the memory, makes a state of the touchpanel from an inactive state to an active state when an external terminal is connected to the display device, detects a type of an action, based on the contact position of the object detected by the touchpanel in the active state, changes the shelf label image displayed on the display in accordance with the type of the action.

### BRIEF DESCRIPTION OF THE DRAWINGS

FIG. 1 is a block diagram showing a configuration example of an electronic shelf label system according to one embodiment.

FIG. 2 is a diagram showing an example of an appearance of a display device displaying a shelf label image.

FIG. 3 is a block diagram showing an example of a hardware configuration of the display device.

FIG. 4 is a block diagram showing an example of a main functional configuration of the display device.

FIG. 5 is a diagram for explaining a touch detection function of a touchpanel.

FIG. 6 is a flowchart showing an example of a procedure carried out by the display device.

FIG. 7 is a flowchart for explaining a part of the process shown in FIG. 6 more specifically.

FIG. 8 is a diagram showing a specific example of an image editing process associated with tapping.

FIG. 9 is a diagram showing a specific example of an image editing process associated with dragging.

FIG. 10 is a diagram showing a specific example of an image editing process associated with spreading.

FIG. 11 is a diagram showing a specific example of an image editing process associated with pinching.

FIG. 12 is a diagram showing a specific example of another image editing process associated with spreading.

FIG. 13 is a diagram showing a specific example of another image editing process associated with pinching.

FIG. 14 is a diagram showing a specific example of another image editing process associated with dragging.

FIG. 15 is a block diagram showing a configuration example of the electronic shelf label system differing from that of FIG. 1.

FIG. 16 is a flowchart showing an example of a procedure carried out by the electronic shelf label system shown in FIG. 15.

### DETAILED DESCRIPTION

In general, according to one embodiment, a display device comprises a display, a touchpanel, a memory and a processor. The display displays a shelf label image including a product information item of a product displayed on a display shelf. The touchpanel in or on the display detects a contact position of an object. The processor executes a program stored in the memory. The processor makes a state of the touchpanel from an inactive state to an active state when an external terminal is connected to the display device. The processor detects a type of an action, based on the contact position of the object detected by the touchpanel in the active state. The processor changes the shelf label image displayed on the display in accordance with the type of the action.

According to one embodiment, an electronic shelf label system comprises a display device, a user terminal and a server device. The display device displays a shelf label image including a product information item of a product displayed on a display shelf. The user terminal is a terminal operated separately from the display device. The user terminal comprises a display, a touchpanel and a communication module for connecting to another device. The touchpanel in or on the display detects a contact position of an object. The server device comprises a storage that stores an image data item of the shelf label image displayed by the display device. The user terminal receives the image data item of the shelf label image. The user terminal displays the shelf label image on the display. The user terminal transmits a positional information item indicating the contact position of the object detected by the touchpanel to the server device. The server device receives the positional information item. The server device detects a type of an action based on the received positional information item. The server device changes the image data item of the shelf label image stored in the storage in accordance with the type of the action. The server device transmits an image data item of the shelf label image changed to the display device via the user terminal.

According to one embodiment, an electronic shelf label system comprises a display device and a user terminal. The display device displays a shelf label image including a product information item of a product displayed on a display shelf. The user terminal is a terminal operated separately from the display device. The user terminal comprises a display, a touchpanel and a communication module for connecting to the display device. The display displays an image. The touchpanel in or on the display detects a contact position of an object. The user terminal receives an image data item of the shelf label image. The user terminal displays the shelf label image on the display. The user terminal detects a type of an action of user, based on a positional information item indicating the contact position of the object detected by the touchpanel. The user terminal changes the image data item of the shelf label image in accordance with the type of the action. The user terminal transmits an image data item of the shelf label image changed to the display device.

Embodiments will be described hereinafter with reference to the accompanying drawings. The disclosure is merely an example, and proper changes within the spirit of the invention, which are easily conceivable by a person having ordinary skill in the art, are included in the scope of the present invention as a matter of course. In the specification and drawings, structural elements that have the same or similar functions as or to those described in connection with preceding drawings are denoted by the same reference symbols, and an overlapping detailed description thereof is omitted unless necessary.

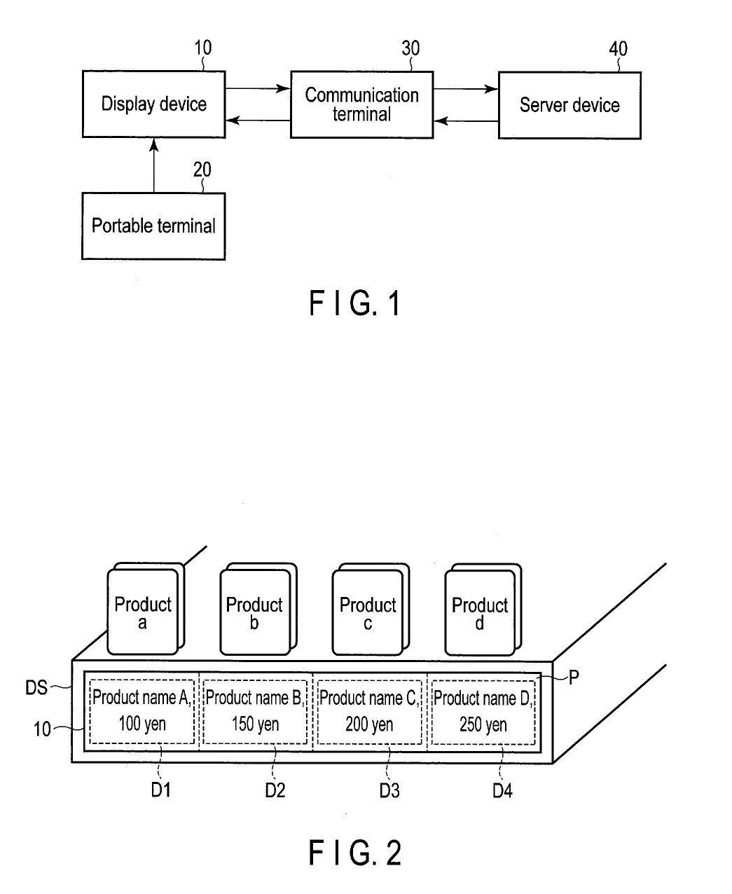

FIG. 1 is a block diagram showing a configuration example of an electronic shelf label system according to an embodiment. The electronic shelf label system shown in FIG. 1 is a system used in stores such as supermarkets or retail stores, and is composed of a display device 10, a portable terminal 20, a communication terminal 30, and a server device 40. FIG. 1 shows only one display device 10 for convenience. In reality, the electronic shelf label system includes a plurality of display devices 10.

The display device 10 is a so-called electronic shelf label (ESL), and is mounted on a display shelf on which a plurality of products are displayed. The description herein assumes that one display device that is horizontally elongated is mounted on one row of the display shelf. However, there are no limitations, and it is also possible that a plurality of display devices are mounted on one row of the display shelf. That is, it is also possible that one display device is mounted for each fixed number of products of the products displayed on one row of the display shelf.

The display device 10 displays a shelf label image showing an information item on a product displayed on the display shelf (hereinafter, referred to as “product information item”). The product information item is an information item indicating at least a product name and a price of a product indicated by the product name. The product information item may further indicate a comment on the product (for example, “Bargain”, “Manager's Choice”, or “Sold Out”), as well as the product name and the price.

An example of an appearance of the display device 10 displaying the shelf label image is herein described with reference to FIG. 2. The display device 10 shown in FIG. 2 is mounted on a front edge of a display shelf DS on which products are displayed. In the case of FIG. 2, the display device 10 shows one shelf label image P including four product information items D1 to D4. The product information item D1 included in the shelf label image P indicates that a product name of a product a is “A”, and its price is “100 yen”. The same is true of the other product information items D2 to D4. Thus, a detailed description thereof is omitted herein.

In FIG. 2, four product information items are displayed by the one display device 10. However, there are no limitations, and it is also possible to adopt the structure wherein shelf label images each showing one product information item are displayed in a time-divisional manner.

FIG. 1 is referred to again. The portable terminal 20 is a terminal (user terminal) possessed by an employee (staff member or user) at a store, and is connected to the display device 10 to activate a touch detection function of the display device 10. The present embodiment assumes the case where the portable terminal 20 is a charging terminal which can supply power to the display device 10, and is connected via a connector provided in the display device 10 with a wire. However, there are no limitations, and for example, the portable terminal 20 may be a terminal which can transmit an instruction signal for activating the touch detection function of the display device 10 to the display device 10, and which is connected to the display device 10 via wireless means.

Also, in general, power is unnecessary for display shelves, unless chilled products or frozen products are displayed on the display shelves. It is therefore difficult to supply power to the display device 10 mounted on the display shelf stably. Thus, in general, the display device 10 does not execute a complex process that consumes much power. However, since the portable terminal 20 is a charging terminal as described above, the display device 10 can be supplied with power stably. This makes it possible to execute an image editing process, which will be described later, stably.

The communication terminal 30 is a relay (router) which is provided near the display device 10, for example, on the display shelf on which the display device 10 is mounted, and connects the display device 10 and the server device 40 so that they can communicate with each other.

The server device 40 is provided in a store's office, an information management facility for accumulating information items on the store, etc. Alternatively, the server device 40 may be a server device which executes a cloud computing service. Although not shown in FIG. 1, the server device 40 comprises a first storage device which stores a product information item, a shelf label image generator which generates a shelf label image (for example, an initial image) based on the product information item stored in the first storage device, a communication module which enables communication with the display device 10, and a second storage device which stores an image data item indicating a shelf label image that is currently displayed by the display device 10.

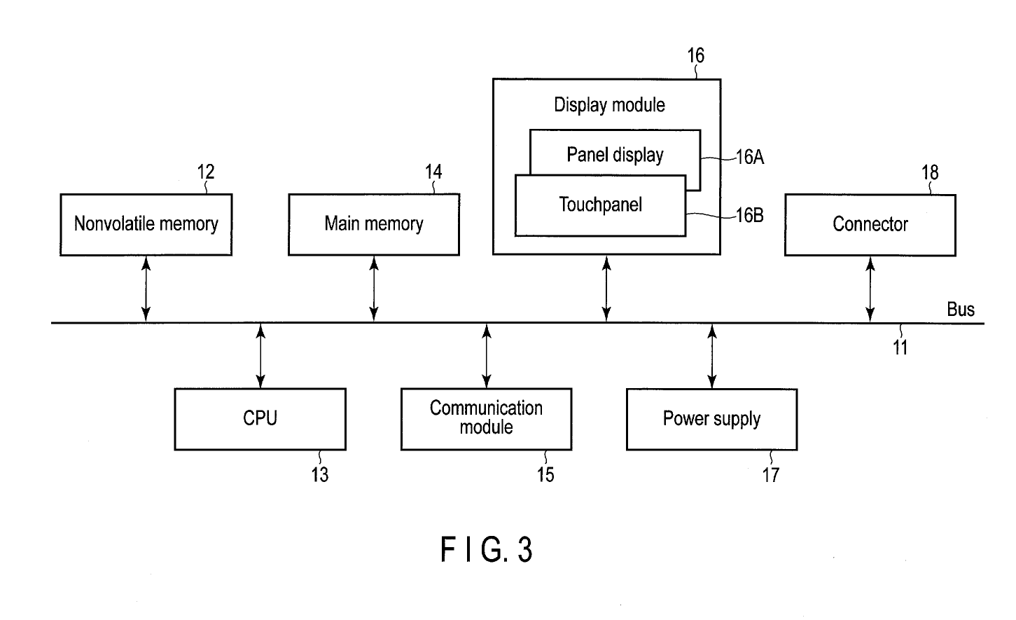

FIG. 3 is a diagram showing an example of a hardware configuration of the display device 10. As shown in FIG. 3, a nonvolatile memory 12, a CPU 13, a main memory 14, a communication module 15, a display module 16, a power supply 17, and a connector 18 are connected to the display device 10 via a bus 11. If the display device 10 and the portable terminal 20 are not connected with a wire, the connector 18 may be omitted from the configuration of the display device 10. Further, the nonvolatile memory 12 and the main memory 14 constitute a storage device of the display device 10.

The nonvolatile memory 12 stores various programs including, for example, an operating system (OS) and a program for updating a shelf label image (which will be described later, and hereinafter referred to as an “image update program”).

The CPU 13 is, for example, a processor which executes various programs stored in the nonvolatile memory 12. The CPU 13 executes control over the operation of the entire display device 10.

The main memory 14 is used as, for example, a work area that is necessary when the CPU 13 executes various programs. FIG. 3 shows only the nonvolatile memory 12 and the main memory 14. However, the display device 10 may comprise other storage devices, such as a hard disk drive (HDD) and a solid state drive (SSD).

The communication module 15 has the function of controlling communication with the server device 40 via the communication terminal 30. Also, the communication module 15 can carry out a wireless communication function via, for example, wireless LAN and Wi-Fi (registered trademark).

The display module 16 comprises a panel display 16A, and a touchpanel 16B (sensor capable of carrying out a touch detection function) configured to detect a contact position of an object (for example, a finger) on a screen of the panel display 16A. The touchpanel 16B is integrally formed on the panel display 16A. The panel display 16A is, for example, an electronic-paper type display comprising an electrophoretic element, etc. In addition, -capacitive type or mutual-capacitive type), a surface capacitive type, a resistive film type, an ultrasonic surface-acoustic-wave type, an optical type, etc.

The power supply 17 supplies power to each module of the display device 10. The connector 18 is a terminal portion (plug) for connecting to the portable terminal 20 with a wire. The CPU 13 activates the touch detection function of the touchpanel 16B constituting the display module 16 when detecting that the portable terminal 20 is connected to the connector 18. The contact position contacted by a finger on the screen thereby can be detected.

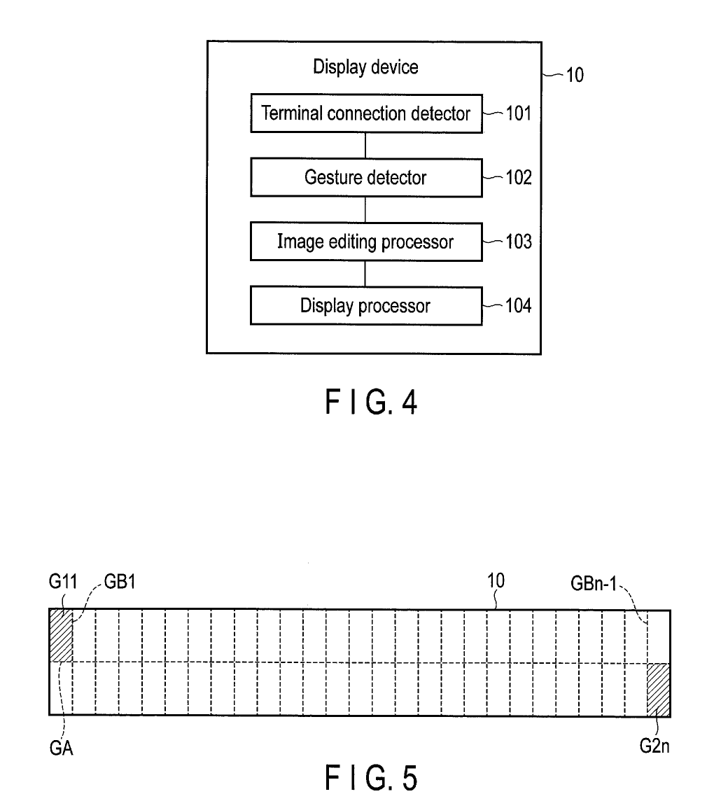

A main functional configuration of the display device 10 carried out when the CPU 13 executes the above image update program will be next described with reference to FIG. 4. FIG. 4 is a block diagram showing an example of the main functional configuration of the display device 10. As shown in FIG. 4, the display device 10 comprises a terminal connection detector 101, a gesture detector 102, an image editing processor 103, a display processor 104, etc.

The terminal connection detector 101 detects that the portable terminal 20 is connected to the display device 10. For example, the terminal connection detector 101 detects that the portable terminal 20 is connected to the display device 10, based on a connection signal generated when the portable terminal 20 is connected to the connector 18 of the display device 10 with a wire. Alternatively, the terminal connection detector 101 detects that the portable terminal 20 is connected to the display device 10, based on an instruction signal transmitted from the portable terminal 20 via wireless means. The terminal connection detector 101 also detects that the portable terminal 20 is detached from the display device 10, based on the above connection signal and instruction signal.

The terminal connection detector 101 activates the touch detection function of the touchpanel 16B constituting the display module 16 (switches the touch detection function of the touchpanel 16B to an active state), when detecting that the portable terminal 20 is connected to the display device 10. In contrast, the terminal connection detector 101 deactivates the touch detection function of the touchpanel 16B (switches the touch detection function of the touchpanel 16B to an inactive state), when detecting that the portable terminal 20 is detached from the display device 10.

In this manner, the touch detection function of the touchpanel 16B is activated only when the portable terminal 20 is connected to the display device 10. This can prevent the touchpanel 16B from being operated by a person other than employees (for example, a child).

The touchpanel 16B is configured to detect the occurrence of events such as “touch (contact)”, “move (slide)”, and “release”, relating to a touch operation, when the touch detection function is active.

The “touch” event is an event indicating that an object (finger) contacts the screen. The “move” event is an event indicating that a contact position contacted by the finger moves while the finger contacts the screen. The “release” event is an event indicating that the finger is released from the screen.

As shown in FIG. 5, the touch detection function of the touchpanel 16B is activated for each area defined by grid lines GA and GB1 to GBn-1. Further, the above events include a grid information item by which an area can be identified, as an information item indicating a contact position contacted by a finger. FIG. 5 assumes the case where the touchpanel 16B is divided into areas G11 to G2n, that is, 2×n areas. The length in the lateral direction of one area is, for example, 5 mm to 1 cm. In addition, the length in the longitudinal direction of one area is, for example, half the length in the longitudinal direction of the touchpanel 16B. In the present embodiment, the grid lines GA and GB1 to GBn-1 are invisible. However, the grid lines GA and GB1 to GBn-1 may be represented by lines having a thickness that can be visually recognized when being approached closer than usual. Further, as the structure wherein the touch function is activated for each of the above areas, it is possible to adopt the structure wherein an electrode for touch is provided for each area or the structure wherein a touch signal is supplied to each area in a time-divisional manner.

In this manner, the touch detection function of the touchpanel 16B is activated for each of the above areas. Thus, the occurrence of the above events can be detected broadly to a certain extent, that is, without the necessity to detect details. Accordingly, power consumption can be reduced.

The gesture detector 102 receives the “touch”, “move” and “release” events detected by the active touchpanel 16B, and detects an employee's gesture (type of movement or type of action), based on the received events.

The image editing processor 103 executes an image editing process associated with the employee's gesture detected by the gesture detector 102 for a shelf label image displayed by the display module 16. An image data item indicating the edited shelf label image is output to the communication module 15 by the image editing processor 103, and transmitted (transferred) to the server device 40 via the communication terminal 30 by the communication module 15. An image data item stored in the second storage device of the server device 40 is thereby rewritten by the edited image data item, and the electronic shelf label system is updated.

The display processor 104 outputs an image data item of a shelf label image to the panel display 16A constituting the display module 16, and causes the shelf label image to be displayed.

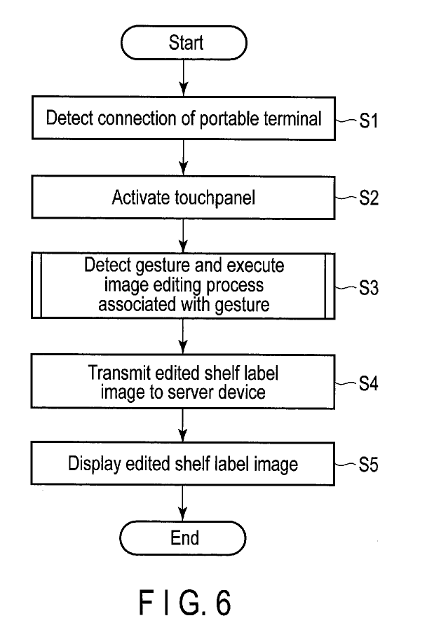

An example of a procedure carried out by the main functional configuration of the display device 10 when the portable terminal 20 is connected to the display device 10 will be herein described with reference to the flowchart of FIG. 6.

First, the terminal connection detector 101 detects that the portable terminal 20 is connected to the display device 10 (step Si). Then, the touch detection function of the touchpanel 16B constituting the display module 16 is switched from an inactive state to an active state. The terminal connection detector 101 makes a state of the touchpanel 16B from an inactive state to an active state (step S2).

Next, the gesture detector 102 detects (identifies) an employee's gesture, based on the occurrence of each event detected by the touchpanel 16B. The gesture detector 102 detects a type of an action of a user, based on the contact position of the object detected by the touchpanel 16B in the active state. The image editing processor 103 executes an image editing process of editing a shelf label image in accordance with the gesture detected by the gesture detector 102. The image editing processor 103 changes the shelf label image by the displayed by the display in accordance with the type of the action of the user (step S3).

Subsequently, the image editing processor 103 outputs an image data item of the shelf label image edited in the process of step S3 to the communication module 15. The image data item of the edited shelf label image is thereby transmitted to the server device 40 via the communication terminal 30 by the communication module 15, and the electronic shelf label system is updated (step S4).

Then, the display processor 104 outputs the image data item of the shelf label image edited in the process of step S3 to the display module 16, causes the edited shelf label image to be displayed on the panel display 16A (step S5), and ends the process herein.

Further, the terminal connection detector 101 switches the touch detection function of the touchpanel 16B from an active state to an inactive state, when detecting that the portable terminal 20 is detached from the display device 10.

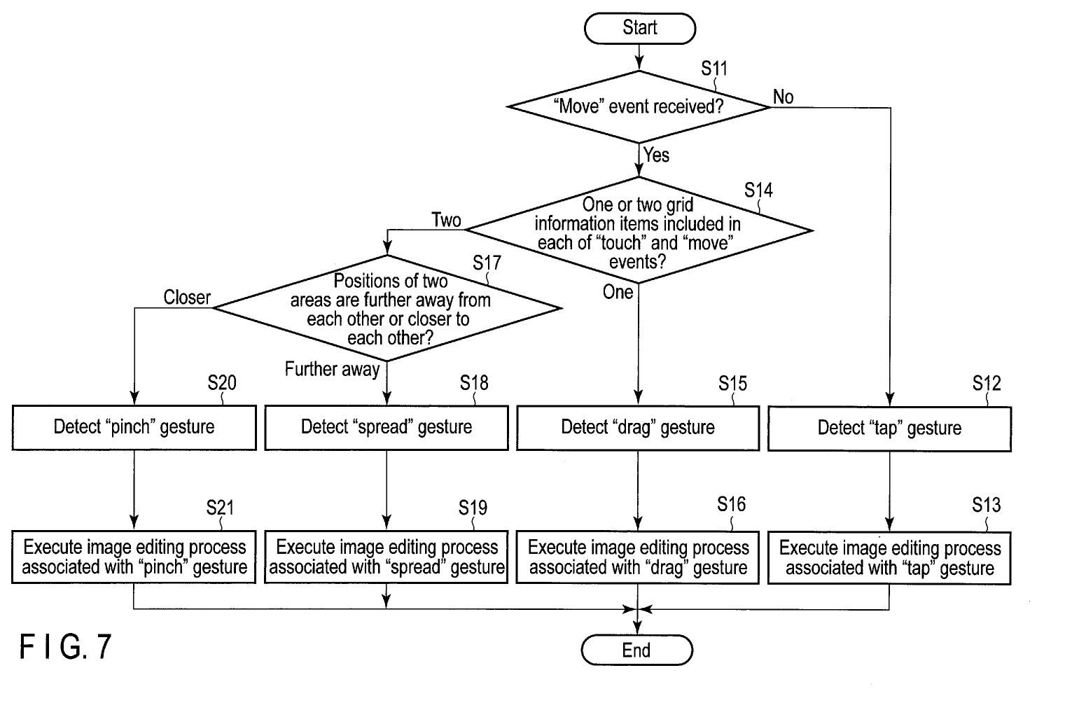

A detailed procedure of step S3 shown in FIG. 6 will be next described with reference to the flowchart of FIG. 7.

First, the gesture detector 102 determines whether a “move” event is received (step S11).

If it is determined that the “move” event is not received, that is, only “touch” and “release” events are received, in the process of step S11 (NO in step S11), the gesture detector 102 detects that a “tap” gesture is made in an area (contact position) indicated by a grid information item (positional information item) included in the received “touch” event (step S12).

The “tap” gesture is a gesture indicating that a finger contacts one point on the screen and is released without being moved, that is, one point on the screen is pressed. Further, the “tap” gesture in the present embodiment also includes “double tap”, which means pressing one point on the screen twice successively.

Then, the image editing processor 103 executes an image editing process associated with “tap” gesture detected by the gesture detector 102 (step S13).

To be specific, the image editing processor 103 executes the process of interchanging an image portion (first portion) including a predetermined product information item, which is displayed in the area indicated by the grid information item included in the “touch” event, and an image portion (second portion) including another product information item, which is displayed next to the first portion. That is, the image editing processor 103 executes the process of interchanging an image portion displayed at a position contacted by a finger and an image portion displayed next to the image portion.

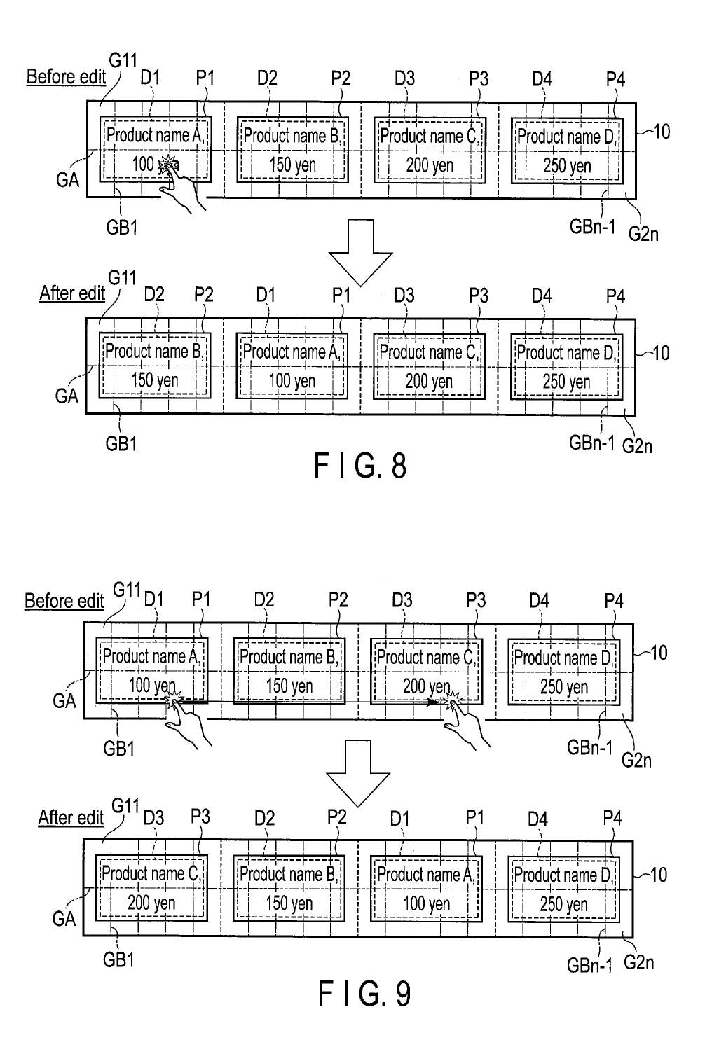

This situation is shown in FIG. 8. FIG. 8 is a diagram showing a specific example of the image editing process associated with the “tap” gesture. As shown in FIG. 8, the image editing processor 103 executes the process of interchanging an image portion P1 including the product information item D1, which is displayed at a position contacted by a finger, and an image portion P2 including the product information item D2, which is displayed next to the image portion P1. Through this process, as shown in FIG. 8, the image portion P2 including the product information item D2 is displayed at the position where the image portion P1 was displayed, and the image portion P1 including the product information item D1 is displayed at the position where the image portion P2 was displayed.

Accordingly, an employee interchanges the positions of the product (product a) of the product name A indicated by the product information item D1 and a product (product b) of a product name B indicated by the product information item D2. In addition, at that time, the employee can handle the interchange between the product a and the product b simply by “tapping” the displayed image portion P1 including the product information item Dl.

FIG. 8 illustrates the case where the image portion P1 displayed at the “tapped” position and the image portion P2 displayed next to the “tapped” position on the right are interchanged. The present embodiment is not limited to this, and it can be optionally determined for which of the right and left image portions, the image portion displayed at the “tapped” position is exchanged.

FIG. 7 is referred to again. If it is determined that the “move” event is received, that is, each of the “touch”, “move” and “release” events is received, in the above-described process of step S11 (YES in step S11), the gesture detector 102 determines whether one or two grid information items are included in each of the “touch” and “move” events (step S14).

If it is determined that one grid information item is included in each of the “touch” and “move” events in the process of step S14 (“One” in step S14), the gesture detector 102 detects that a “drag(-and-drop)” gesture is made (step S15). The “drag(-and-drop)” gesture is a gesture by which a finger is moved from the area indicated by the grid information item included in the “touch” event to an area indicated by a grid information item included in the “move” event.

Next, the image editing processor 103 executes an image editing process associated with the “drag” gesture detected by the gesture detector 102 (step S16).

To be specific, the image editing processor 103 executes the process of interchanging an image portion (first portion) including a predetermined product information item, which is displayed in the area indicated by the grid information item included in the “touch” event, and an image portion (second portion) including another product information item, which is displayed in the area indicated by the grid information item included in the “move” event. That is, the image editing processor 103 executes the process of interchanging an image portion displayed at a position contacted by a finger and an image portion displayed at a position from which the finger is released.

This situation is shown in FIG. 9. FIG. 9 is a diagram showing a specific example of the image editing process associated with the “drag” gesture. As shown in FIG. 9, the image editing processor 103 executes the process of interchanging the image portion P1 including the product information item D1, which is displayed at the position contacted by the finger, and an image portion P3 including the product information item D3, which is displayed at a position, from which the finger is released after being moved. That is, as shown in FIG. 9, the image portion P3 including the product information item D3 is displayed at the position where the image portion P1 was displayed, and the image portion P1 including the product information item D1 is displayed at the position where the image portion P3 was displayed.

Accordingly, the employee interchanges the positions of the product (product a) of the product name A indicated by the product information item D1 and a product (product c) of a product name C indicated by the product information item D3. In addition, at that time, the employee can handle the interchange between the product a and the product c simply by “dragging” the displayed image portion P1 including the product information item D1 and “dropping” it at the position where the image portion P3 including the product information item D3 is displayed.

FIG. 7 is referred to again. If it is determined that two grid information items are included in each of the “touch” and “move” events in the above-described process of step S14 (“Two” in step S14), the gesture detector 102 compares the positions of two areas indicated by the two grid information items included in the “touch” event and the positions of two areas indicated by the two grid information items included in the “move” event. Based on a result of this comparison, the gesture detector 102 determines whether the positions of the two areas are further away from each other than they were before being moved or they are closer to each other than they were before being moved (step S17).

If it is determined that the positions of the two areas are further away from each other than they were before being moved in the process of step S17 (“Further away” in step S17), the gesture detector 102 detects that a “spread” gesture is made (step S18).

Then, the image editing processor 103 executes an image editing process associated with the “spread” gesture detected by the gesture detector 102 (step S19).

To be specific, the image editing processor 103 executes the process of enlarging an image portion including a predetermined product information item, which is displayed near the two areas (for example, between the two areas) indicated by the two grid information items included in the “touch” event, greater than it originally was.

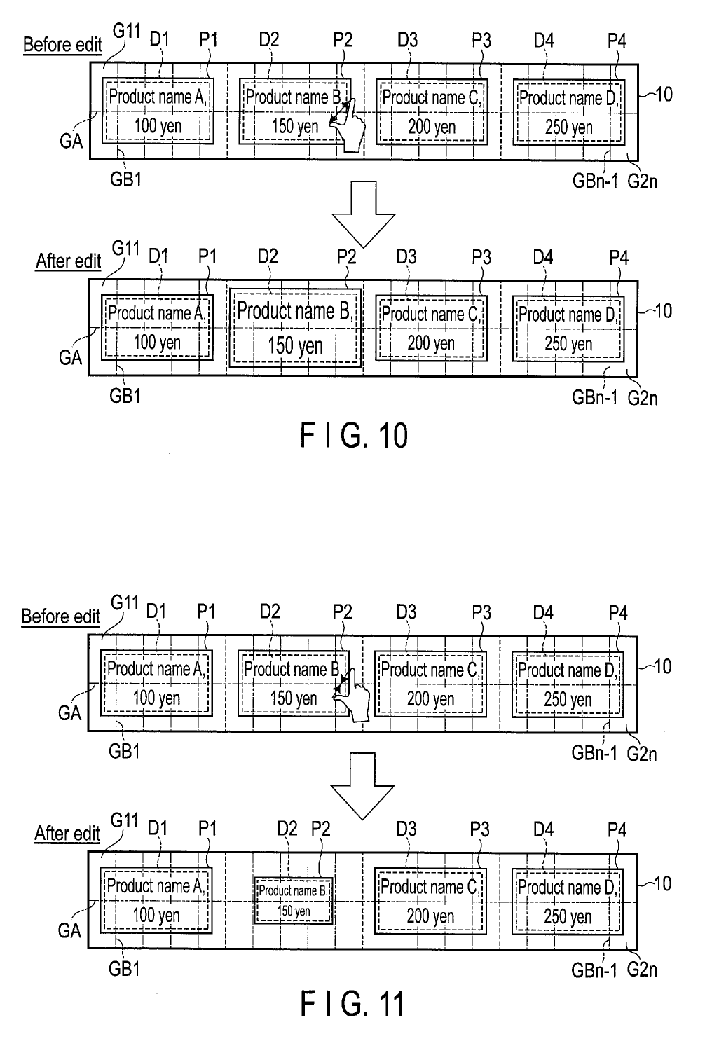

This situation is shown in FIG. 10. FIG. 10 is a diagram showing a specific example of the image editing process associated with the “spread” gesture. As shown in FIG. 10, the image editing processor 103 executes the process of enlarging the image portion P2 including the product information item D2, which is displayed near the positions contacted by two fingers, in accordance with the distance between the two fingers that are moved away from each other. More specifically, the image editing processor 103 executes the process of enlarging the image portion P2, if at least one of the two fingers move away at least from an area in one stage to an area in the other stage of the two upper and lower stages. That is, as shown in FIG. 10, the image portion P2 including the product information item D2 is displayed with emphasis greater than the other image portions.

For example, it is assumed that the employee wishes to display the product (product b) of the product name B indicated by the product information item D2 as a bargain. In this case, the employee can handle this simply by “spreading” the displayed image portion P2 including the product information item D2.

FIG. 7 is referred to again. If it is determined that the positions of the two areas are closer to each other than they were before being moved in the above-described process in step S17 (“Closer” in step S17), the gesture detector 102 detects that a “pinch” gesture is made (step S20).

Next, the image editing processor 103 executes an image editing process associated with the “pinch” gesture detected by the gesture detector 102 (step S21).

To be specific, the image editing processor 103 executes the process of shrinking the image portion including the predetermined product information item, which is displayed near the two areas (for example, between the two areas) indicated by the two grid information items included in the “touch” event, smaller than it originally was.

This situation is shown in FIG. 11. FIG. 11 is a diagram showing a specific example of the image editing process associated with the “pinch” gesture. As shown in FIG. 11, the image editing processor 103 executes the process of shrinking the image portion P2 including the product information item D2, which is displayed near the positions contacted by two fingers, in accordance with the distance between the two fingers that are moved closer to each other. More specifically, the image editing processor 103 executes the process of shrinking the image portion P2, if at least one of the two fingers move closer at least from an area in one stage to an area in the other stage of the two upper and lower stages. That is, as shown in FIG. 11, the image portion P2 including the product information item D2 is displayed smaller than the other image portions. In other words, the image portions other than the image portion P2 including the product information item D2 are displayed greater than the image portion P2.

For example, it is assumed that the employee wishes to display the products except the product (product b) of the product name B indicated by the product information item D2 with emphasis as bargains. In this case, the employee can handle this simply by “pinching” the displayed image portion P2 including the product information item D2, not by enlarging each of the image portions including the respective product information items on the products except the product b by “spreading” them.

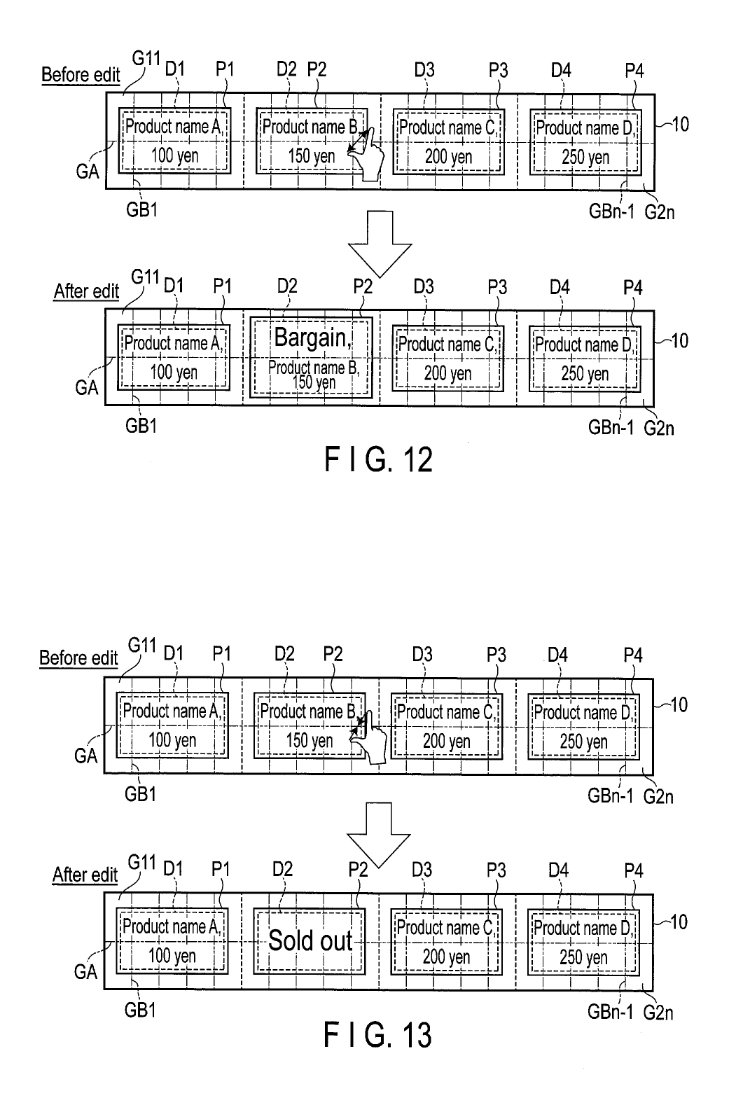

FIG. 10 illustrates the case where the image portion including the predetermined product information item, which is displayed near the positions contacted by the two fingers, is enlarged greater than it originally was, as the image editing process associated with the “spread” gesture. However, the image editing process associated with the “spread” gesture is not limited to this. For example, as shown in FIG. 12, it is also possible to further display (insert) a comment recommending the product of the product information item included in the image portion displayed near the positions contacted by the two fingers, specifically, characters such as “Bargain”. FIG. 12 illustrates the case where the “spread” gesture is made, and thus, the characters “Bargain” are displayed in the upper stage of the display and the product name and the price are displayed in the lower stage of the display.

FIG. 11 illustrates the case where the image portion including the predetermined product information item, which is displayed near the positions contacted by the two fingers, is shrunk smaller than it originally was, as the imager editing process associated with the “pinch” gesture. However, the image editing process associated with the “pinch” gesture is not limited to this. For example, as shown in FIG. 13, it is possible to display (insert) a comment to the effect that the product of the product information item included in the image portion displayed near the positions contacted by the two fingers is sold out, that is, characters “Sold Out”, instead of the product information item. FIG. 13 illustrates the case where only the characters “Sold Out” are displayed. However, it is also possible to display the characters “Sold Out” in the upper stage of the display and display the product name and the price in the lower stage of the display as shown in FIG. 12.

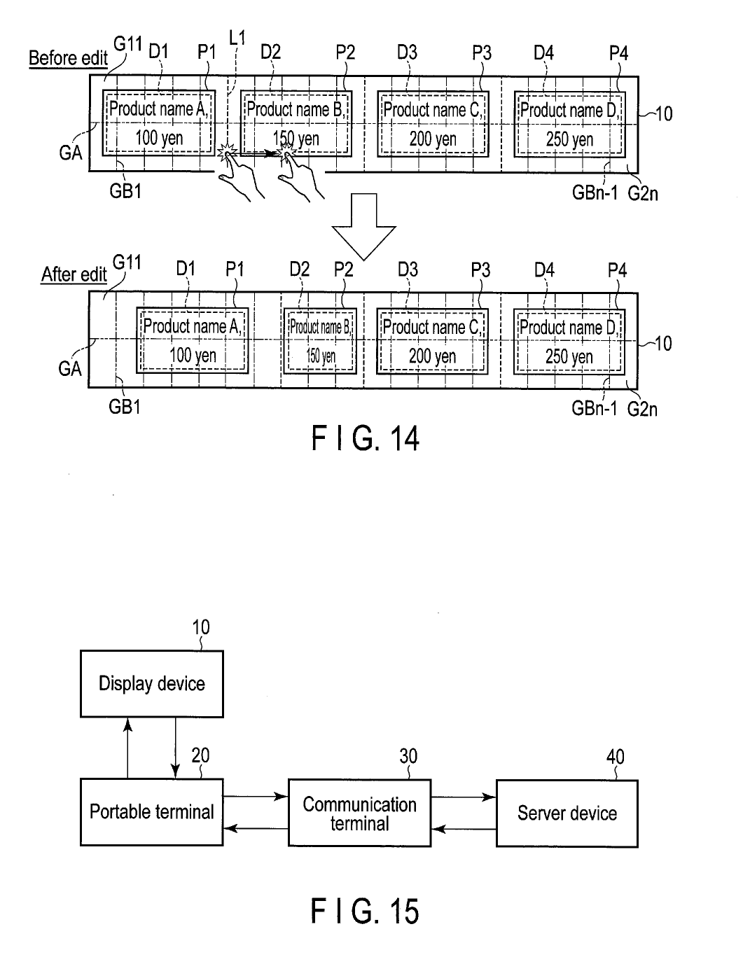

In the present embodiment, the case where an image portion including a product information item included in a shelf label image is edited (changed) through an image editing process has been described. However, as shown in FIG. 14, it is also possible to change the area (display position) where the image portion including the product information item is displayed by detecting an employee's gesture made on a partition line included in the shelf label image. FIG. 14 illustrates the case where a partition line L1 located between the displayed image portion P1 including the product information item D1 and the displayed image portion P2 including the product information item D2 is moved (dragged) to the right. In this case, the shelf label image is edited, such that the area where the image portion P1 is displayed becomes wider and the area where the image portion P2 is displayed becomes narrower.

In the present embodiment, the case where a shelf label image is edited by the display device 10 has been described. However, for example, it is also possible that the portable terminal 20 is a smartphone or a tablet terminal, and the shelf label image is edited by the server device 40 in accordance with the employee's operation of the portable terminal 20. In this case, the process of editing the shelf label image is executed by the server device 40, while the employee just need to operate the portable terminal 20 on site. Thus, the employee can easily change the shelf label image on site. The configuration in this case is shown in FIG. 15.

FIG. 15 is a block diagram showing a configuration example of the electronic shelf label system in the case where the shelf label image is edited, not by the display device 10, but by the server device 40.

The display device 10 shown in FIG. 15 is not a device comprising a touchpanel unlike that of FIG. 1, and may be any device that can simply display the shelf label image on a display. The display device 10 comprises a storage device storing an image data item of the shelf label image displayed on the display.

The portable terminal 20 is a device comprising a touchpanel, such as a smartphone or a tablet terminal, and is connected to the display device 10 to be able to communicate with the display device 10 with a wire or via wireless means. In addition, the portable terminal 20 is connected to the server device 40 to be able to communicate with the server device 40 via the communication terminal 30 via wireless means.

The server device 40 comprises a processor having the same functions as the gesture detector 102 and the image editing processor 103 described above. In addition, the server device 40 comprises a storage device (second storage device) storing an image data item of a shelf label image displayed by the display device 10.

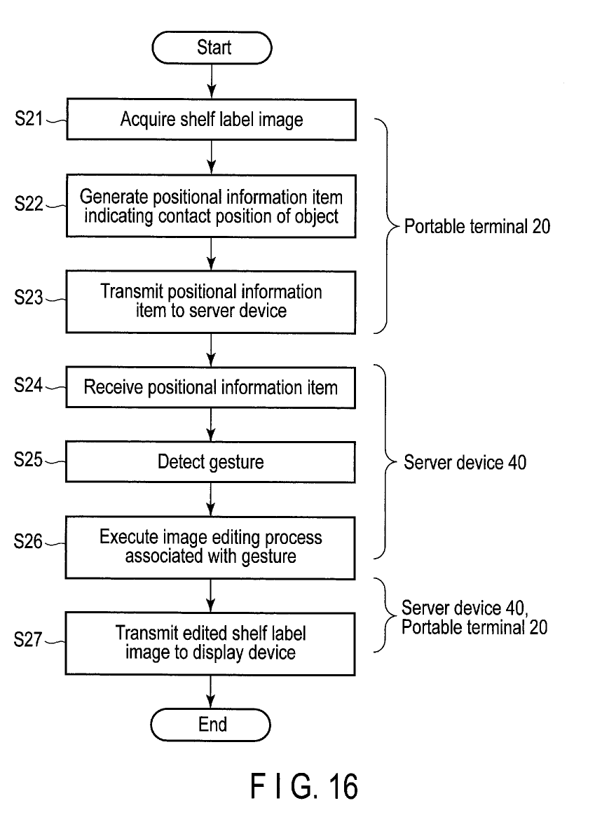

An example of a procedure carried out by the electronic shelf label system shown in FIG. 15 will be herein described with reference to the flowchart of FIG. 16.

First, the portable terminal 20 connects to the display device 10 with a wire or via wireless means, and acquires an image data item of a shelf label image that is currently displayed by the display device 10 (step S21). If the display device 10 is not provided with the storage device storing the image data item of the shelf label image, the portable terminal 20 acquires the image data item from the server device 40.

The shelf label image indicated by the acquired image data item is displayed on the display of the portable terminal 20. The employee performs an edit operation of the shelf label image on the display.

In response to this operation, the portable terminal 20 generates a positional information item indicating a contact position of an object detected by the touchpanel, and transmits it to the server device 40 (steps S22 and S23).

The server device 40 receives the positional information item transmitted from the portable terminal 20 (step S24). Then, the server device 40 detects the employee's gesture based on the received positional information item (step S25).

The server device 40 executes an image editing process associated with the detected employee's gesture for the image data item of the shelf label image stored in the second storage device (step S26).

Then, the server device 40 transmits the edited image data item to the portable terminal 20. The edited image data item is further transmitted to the display device 10 by the portable terminal 20 (step S27). A shelf label image indicated by the edited image data item is thereby displayed by the display device 10.

Here, the case where the server device 40, which have acquired a positional information item from the portable terminal 20, executes an image editing process, transmits the edited image data item to the portable terminal 20, and updates the shelf label image has been described. However, there are no limitations, and the image editing process may be executed by the portable terminal 20. In this case, the portable terminal 20 generates a positional information item in the above-described process of step S22, and then detects the employee's gesture based on the generated positional information item and executes an image editing process associated with the detected employee's gesture. The edited image data item is transmitted to the display device 10 to update the shelf label image, and also transmitted to the server device 40 to rewrite the image data item stored in the second storage device.

If the image editing process is executed by the portable terminal 20 as described above, the employee may execute the image editing process, not only by operating the touchpanel, but also by operating an input interface (for example, a keyboard or a mouse) corresponding to the portable terminal 20.

As described above, according to the present embodiment, the display device and the electronic shelf label system which enable a shelf label image to be easily changed on site can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, in the present embodiment, the structure wherein the horizontally elongated display device 10 is provided is adopted. However, it is also possible to adopt the structure wherein a plurality of display devices are joined horizontally to be horizontally elongated like the above display device. In this case, it is also possible that a touchpanel is provided for each individual display device, or a touchpanel is mounted on the display devices joined together.

What is claimed is:

1. A display device comprising:
a display that displays a shelf label image including a product information item of a product displayed on a display shelf;
a touchpanel in or on the display and that detects a contact position of an object;
a memory; and
a processor that executes a program stored in the memory,
makes a state of the touchpanel from an inactive state to an active state when an external terminal is connected to the display device,
detects a type of an action, based on the contact position of the object detected by the touchpanel in the active state,
changes the shelf label image displayed on the display in accordance with the type of the action.

2. The display device of claim 1, wherein the processor transmits an image data item of the shelf label image changed to a server device for managing the image data item of the shelf label image.

3. The display device of claim 1, wherein
the shelf label image displayed on the display includes a first portion of a first product and a second portion of a second product adjacent to the first portion,
the processor interchanges the first portion with the second portion, when the type of the action is tapping a place where the first portion is displayed.

4. The display device of claim 1, wherein
the shelf label image displayed on the display includes a first portion of a first product and a second portion of a second product away from the first portion,
the processor interchanges the first portion with the second portion, when the type of the action is dragging that the contact position moves from the first portion to the second portion.

5. The display device of claim 1, wherein
the shelf label image displayed on the display includes a first portion of a first product,
the touchpanel detects two contact positions,
the processor enlarges the first portion, when the type of the action is spreading that a distance of the two contact positions increases at or near the first portion.

6. The display device of claim 1, wherein
the shelf label image displayed on the display includes a first portion of a first product,
the touchpanel detects two contact positions,
the processor shrinks the first portion, when the type of the action is pinching that a distance of the two contact positions decreases at or near the first portion.

7. The display device of claim 1, wherein
the shelf label image displayed on the display includes a first portion of a first product,
the touchpanel detects two contact positions,
the processor
inserts a first comment into the first portion, when the type of the action is spreading that a distance of the two contact positions increases at or near the first portion, and
inserts a second comment differing from the first comment into the first portion, when the type of the action is pinching that a distance of the two contact positions decreases at or near the first portion.

8. An electronic shelf label system comprising:
a display device that displays a shelf label image including a product information item of a product displayed on a display shelf;
a user terminal which is a terminal operated separately from the display device, the user terminal comprising,
a display,
a touchpanel in or on the display that detects a contact position of an object, and
a communication module for connecting to another device; and
a server device comprising,
a storage that stores an image data item of the shelf label image displayed by the display device, wherein
the user terminal that
receives the image data item of the shelf label image;
displays the shelf label image on the display; and
transmits a positional information item indicating the contact position of the object detected by the touchpanel to the server device,
the server device that
receives the positional information item;
detects a type of an action based on the received positional information item;
changes the image data item of the shelf label image stored in the storage in accordance with the type of the action; and
transmits an image data item of the shelf label image changed to the display device via the user terminal.

9. The electronic shelf label system of claim 8, wherein
the shelf label image displayed on the display includes a first portion of a first product and a second portion of a second product adjacent to the first portion,
the server device interchanges the first portion with the second portion, when the type of the action is tapping a place where the first portion is displayed.

10. The electronic shelf label system of claim 8, wherein
the shelf label image displayed on the display includes a first portion of a first product and a second portion of a second product away from the first portion,
the server device interchanges the first portion with the second portion, when the type of the action is dragging that the contact position moves from the first portion to the second portion.

11. The electronic shelf label system of claim 8, wherein
the shelf label image displayed on the display includes a first portion of a first product,
the touchpanel detects two contact positions,
the server device enlarges the first portion, when the type of the action is spreading that a distance of the two contact positions increases at or near the first portion.

12. The electronic shelf label system of claim 8, wherein
the shelf label image displayed on the display includes a first portion of a first product,
the touchpanel detects two contact positions,
the server device shrinks the first portion, when the type of the action is pinching that a distance of the two contact positions decreases at or near the first portion.

13. The electronic shelf label system of claim 8, wherein
the shelf label image displayed on the display includes a first portion of a first product,
the touchpanel detects two contact positions,
the server device
inserts a first comment into the first portion, when the type of the action is spreading that a distance of the two contact positions increases at or near the first portion, and
inserts a second comment differing from the first comment into the first portion, when the type of the action is pinching that a distance of the two contact positions decreases at or near the first portion.

14. An electronic shelf label system comprising:
a display device that displays a shelf label image including a product information item of a product displayed on a display shelf; and
a user terminal which is a terminal operated separately from the display device, the user terminal comprising,
a display,
a touchpanel in or on the display that detects a contact position of an object, and
a communication module for connecting to the display device,
the user terminal that
receives an image data item of the shelf label image;
displays the shelf label image on the display;
detects a type of an action of user, based on a positional information item indicating the contact position of the object detected by the touchpanel;
changes the image data item of the shelf label image in accordance with the type of the action; and
transmits an image data item of the shelf label image changed to the display device.

15. The electronic shelf label system of claim 14, wherein
the shelf label image displayed on the display includes a first portion of a first product and a second portion of a second product adjacent to the first portion,
the user terminal interchanges the first portion with the second portion, when the type of the action is tapping a place where the first portion is displayed.

16. The electronic shelf label system of claim 14, wherein
the shelf label image displayed on the display includes a first portion of a first product and a second portion of a second product away from the first portion,
the user terminal interchanges the first portion with the second portion, when the type of the action is dragging that the contact position moves from the first portion to the second portion.

17. The electronic shelf label system of claim 14, wherein
the shelf label image displayed on the display includes a first portion of a first product,
the touchpanel detects two contact positions,
the user terminal enlarges the first portion, when the type of the action is spreading that a distance of the two contact positions increases at or near the first portion.

18. The electronic shelf label system of claim 14, wherein
the shelf label image displayed on the display includes a first portion of a first product,
the touchpanel detects two contact positions,
the user terminal shrinks the first portion, when the type of the action is pinching that a distance of the two contact positions decreases at or near the first portion.

19. The electronic shelf label system of claim 14, wherein
the shelf label image displayed on the display includes a first portion of a first product,
the touchpanel detects two contact positions,
the user terminal
inserts a first comment into the first portion, when the type of the action is spreading that a distance of the two contact positions increases at or near the first portion, and
inserts a second comment differing from the first comment into the first portion, when the type of the action is pinching that a distance of the two contact positions decreases at or near the first portion.
